(19) United States
(12) Patent Application Publication
(10) Pub. No.: US 2003/0103519 A1
(43) Pub. Date: Jun. 5, 2003

(54) Remotely controlled electronic interface module for multi-application systems

(76) Inventors: Murali Balasundram, Fort Wayne, IN (US); Michael Allen Campeau, Lansing, MI (US); Ronald Hannold, Charlotte, MI (US); John Hummel, Laingsburg, MI (US); Daryl Duane Hochstetler, Milford, IN (US); Roger Morris Burger, Winona Lake, IN (US)

Correspondence Address: FOSTER, SWIFT, COLLINS & SMITH, P.C., 313 SOUTH WASHINGTON SQUARE, LANSING, MI, 48933, US

(21) Appl. No.: 10/304,818

(22) Filed: Nov. 26, 2002

Related U.S. Application Data
(60) Provisional application No. 60/333,930, filed on Nov. 27, 2001.

(51) Int. Cl. H04B 7/212

(52) U.S. Cl. 370/442; 370/345

(57) ABSTRACT

A time division-multiplexing system for a vehicle, using data signals adapted to pass through the system in a cyclical manner during each of a series of time intervals, comprising at least one system controller. The system controller includes a microcontroller and generates at least one controller output in the form of a multiple byte waveform and the at least one controller output is communicatively connected to a remote system controller. The remote system controller monitors bits in a binary configuration to identify time intervals associated with said at least one controller output.

### CROSS-REFERENCE TO RELATED APPLICATIONS

This application claims priority to U.S. provisional application serial No. 60/333,930 entitled “Remotely Controlled Electronic Interface Module For Multi-Application Systems,” filed Nov. 27, 2001. The entire disclosure of U.S. application serial No. 60/333,930 is incorporated herein by reference in its entirety.

### BACKGROUND OF THE INVENTION

1. Field of the Invention

The present invention relates to an improved time division multiplexing system to control multiple applications, including motor vehicle functions.

2. Background and Description of the Prior Art

Multi-system applications, such as within motor vehicles, have traditionally used conventional point-to-point wiring systems to power, control, or monitor the various system or equipment operations. New vehicle features for safety devices and amenities have placed great demands on the size and complexity of these wiring systems. They can be costly to manufacture and difficult to service.

One way to reduce the size, cost, and complexity of powering, monitoring, and controlling vehicle equipment operations is by using a multiplex system. Multiplexing can send two or more messages on the same communication line, thus reducing the overall number of wires needed in multi-system application situations. A popular type of multiplexing in vehicle applications is time division multiplexing. In this type of multiplexing, a plurality of transmitters transmits signals over a communication line in a cyclical manner to a plurality of receivers responsive to the signals. The receivers are connected to the line, which in turn are coupled to predetermined vehicle components.

Other variations of prior art multiplexing systems may include a single central transmitter that generates a train of pulses. The pulses are encoded using, for example, pulse width or pulse amplitude modulation techniques. Each receiver is responds to a particular pulse in the train, decodes the pulse, and generates an action in the associated application corresponding to instructions encoded by the transmitter.

In other known multiplexing systems, a plurality of transmitter-receiver pairs are connected to a communication line, commonly known as a controller area network or CAN. Each transmitter transmits a data signal over the communication line that is adapted to be received by its associated receiver. In such systems, each transmitter-receiver pair is typically allotted a particular time interval or channel to transmit signals over the communication line. This is called time division multiplexing.

Several time division multiplex systems include two or more wires or busses to transmit power, data, and timing signals through the system. These systems can be costly to manufacture and difficult to service, particularly in the field. Other systems require only a single wire to carry power, timing, and data signals through the system. Unfortunately, these systems are often complex in design and limited in their capabilities.

One time division multiplexing system is described in U.S. Pat. No. 4,907,222 issued to Slavik and utilizes a synchronizing pulse train having one long pulse and nine shorter pulses of equal amplitude. The Slavik system monitors the amplitude of the pulse to determine whether a pulse is a clock or data.

Another type of multiplexing technology known in the art includes the use of isochronous inputs and is described in U.S. Pat. No. 5,541,921 to Swenson et al. In Swenson, an isochronous serial time division multiplexer is applied to personal computers.

These prior art multiplexing systems have limited applications and therefore do not provide the flexibility needed in designing a vehicle control system. They are limited in their size, capacity, versatility, and expandability as they are not based on microcontroller technology and are not designed to be compatible with commercially available vehicle serial data bus systems.

### SUMMARY OF THE INVENTION

The present invention combines a data bit stream with synchronous and isochronous signals to control a variety of vehicle control functions and allow greater volume, variety, and flexibility of vehicle component control. The invention can include an isochronous input from the steering wheel of a vehicle and a synchronous output to the communicating devices on a controller area network or to a remote system controller. The communications are accomplished through multiple byte waveform technology where time interval changes may be determined by monitoring “bytes.” Further, the remote system controller of the present invention is microcontroller based and utilizes a digital voltage signal, which enables functions to be added to the system relatively easily providing a highly flexible control system.

The present invention provides an improved time division-multiplexing system used to control motor vehicle functions and other applications where multiple controllable functions are present. In one embodiment of the present invention a system includes a time division-multiplexing system using data signals adapted to pass through the system in a cyclical manner during each of a series of time intervals. The system comprises at least one system controller generating at least one controller output in the form of a multiple byte waveform. The at least one controller output is communicatively connected to a remote system controller. The remote system controller monitors bits in a binary configuration to identify time intervals associated with at least one controller output.

In another embodiment of the present invention, a time division multiplexing system for a vehicle, using data signals adapted to pass through the system in a cyclical manner during each of a series of time intervals, has at least one system controller generating at least one controller output. This controller output is communicatively connected to the vehicle system controller using microcontroller circuitry and a multiple byte waveform signal to communicate with the vehicle system controller.

In yet another embodiment of the present invention, a time division multiplexing system for a vehicle, using data signals adapted to pass through the system in a cyclical manner during each of a series of time intervals has at least one system controller generating at least one controller output in the form of a multiple byte waveform signal. The at least one controller output is communicatively connected to a serial bus system and the serial bus system is communicatively connected to a vehicle system controller. The vehicle system controller is configured to monitor bits in a binary configuration to identify time intervals associated with the at least one controller output.

Other features of the present invention will become more apparent to persons having ordinary skill in the art to which the present invention pertains from the following description taken in conjunction with the accompanying figures.

### BRIEF DESCRIPTION OF THE FIGURES

The foregoing advantages and features will become apparent with reference to the description and drawings below, in which like numerals represent like elements and in which:

FIG. 1 illustrates a possible basic message format of a multiple byte waveform of the present invention;

FIG. 2 illustrates further detail at a “bit” level of leading byte 0;

FIG. 3 illustrates further detail at a “bit” level of byte 1;

FIG. 4 illustrates an example steady state message of the present invention;

FIG. 5 illustrates an exemplary message of the present invention;

FIGS. 6A & 6B illustrate block diagrams of the communication flow of a system using the present invention;

FIG. 7 illustrates a schematic of a system using the present invention;

FIG. 8 illustrates an exemplary control strategy for cruise set;

FIG. 9 illustrates an exemplary control strategy for cruise resume;

FIG. 10 illustrates an exemplary control strategy for cruise cancel;

FIG. 11 illustrates an exemplary control strategy for wiper off;

FIG. 12 illustrates an exemplary control strategy for wiper variable;

FIG. 13 illustrates an exemplary control strategy for wiper hi/low;

FIG. 14 illustrates an exemplary control strategy for wiper wash;

FIG. 15 illustrates an exemplary control strategy for headlamp flash;

FIG. 16 illustrates an exemplary control strategy for marker lamps flash;

FIG. 17 illustrates an exemplary control strategy for horn; and

FIG. 18 illustrates an exemplary control strategy for DRLM.

### DETAILED DESCRIPTION OF THE INVENTION

The present invention generally relates to an improved time division multiplexing system which can be used to control motor vehicle functions and other applications where multiple controllable functions are present. The time division multiplexing system of the present invention is a form of multiplexing where a control channel is shared by interleaving data pulses, representing “bits” from different channels on a time basis. The present system includes a processing unit capable of communicating with a serial bus system especially suited for networking “intelligent” devices having a standard controller area network (CAN) configuration available in the industry. This system can handle analog, digital, and pulse width modulated signals, individually or in multiple combinations. The present invention can be used for controlling and sensing a plurality of signals with enhanced flexibility.

The present invention demonstrates the use of multiple byte waveform technology in a time division multiplexing system. A multiple byte waveform can be configured where a “bit” is a resultant choice between two alternatives (yes-no; on-off; 0-1) known as binary digits. A “byte” is a group of 8 adjacent bits, and a “waveform” is one full time cycle of a system group of bytes. Multiple byte waveform technology allows information to be transferred within the waveform.

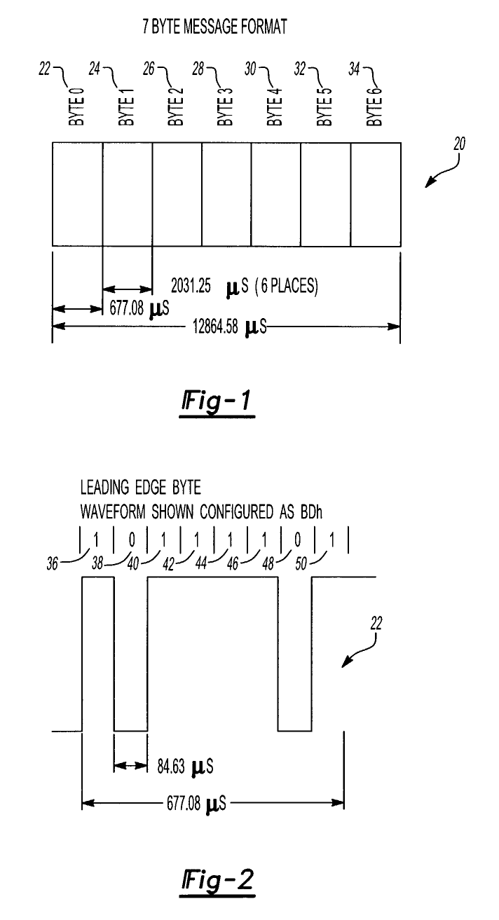

The multiple byte waveforms have a fixed leading byte at the start of each waveform cycle. Each subsequent byte after the fixed leading byte within the waveform can have fixed leading and trailing values on each bit resulting in each bit having 3 components (leading component, message component, and trailing component). In the present invention, a message may be contained in a 7-byte message waveform as shown in FIG. 1. To illustrate, in FIG. 1 a 7-byte waveform message format is generally indicated at 20 with a total duration of 12,864.58 μs. A “leading” or first byte, byte zero 22, signifies the start of the message 20 and is 677.08 μs in duration. The leading byte signifies the “address” for the message. This is an identifier address that is unique to the communicating transmitter and receiver pairs and ensures that the receiver ignores all signals not preceded by this address. Bytes one through six labeled 24, 26, 28, 30, 32 and 34 respectively follow, and are each 2,031.25 μs in duration. The message 20 repeats itself every 12,864.58 μs by looping back to byte zero 22. This example illustrates one possible time sequence, however, other time sequences are possible and known in the art.

Byte zero 22 in message 20 as illustrated in FIG. 1 can start with a minimum value of 80h or a maximum value of FFh. Alphanumeric characters followed by an ‘h’ signify hexadecimal (or base 16) notation which is a more compact notation than binary and is well-known in the art. For this example, time durations are not critical except that the value of byte zero 22 must be different from bytes one through six 24-34. Further, once the value of leading byte, byte zero 22, is established, it must stay the same since it identifies the beginning of the message 20.

Byte zero 22 is illustrated in further detail in FIG. 2 at its “bit” level. In FIG. 2, byte zero 22 is defined by 8 bits 36-50 and given a binary code, for demonstration purposes, of 10111101. Within each 7-byte waveform there are 48 possible instructions (defined by 8 instructions per byte in a 7-byte waveform, excluding leading byte one which only identifies the unique address of the receiver-transmitter pair) and in this case has a time interval of approximately 12,864.58 μs. This high-speed capability increases system capacity.

Bytes one through six 24-34 can all have this same basic format. Each byte can have a 24-component/byte binary configuration and can contain up to 8 instructions within this configuration (3 components for each of 8 bits per byte including a leading high bit, followed by the instruction bit, followed by a trailing low bit). The instruction set for each byte starts with a most significant bit (MSB) and ends with a least significant bit (LSB). If a byte contains no instructions, the byte will be assigned an arbitrary value that is unassigned to any other instruction set.

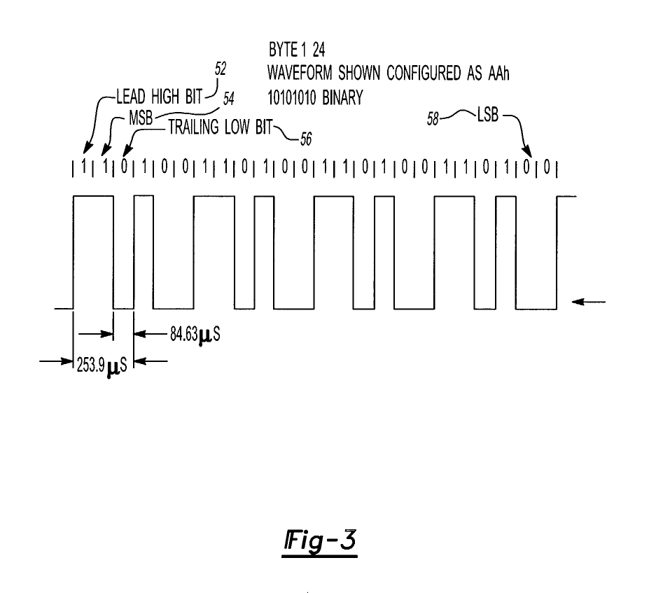

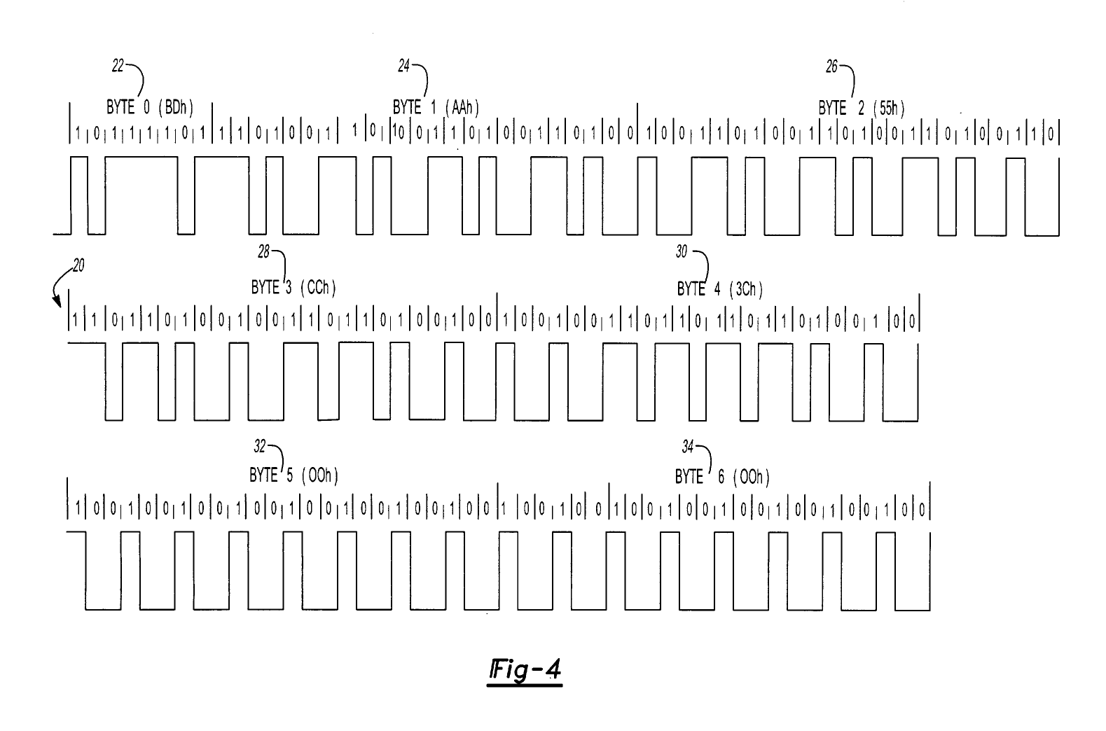

Within each byte 24-34, each bit 36-50 must be led by a high “1” and followed by a low “0.” FIG. 3 demonstrates the formatting of byte one 24 as AAh. AAh is equivalent to the binary number 10101010. In FIG. 3, byte one 24 begins with a lead high bit 52 (“1”), followed by a MSB 54 (“1”) and a trailing low bit 56 (“0”) (thus the 3 components of a bit). A LSB is also defined for byte one 24 shown as LSB 58 (“0”) in FIG. 3. In FIG. 2, byte zero 22 has been set at BDh and in FIG. 3 byte one 24 has been set at AAh. Bytes two 26, three 28 and four 30, also need to be set. The values of bytes two through four 26-30 are purely arbitrary and for demonstration purposes, the values in this example are set to 55h, CCh, and 3Ch for bytes two through four 26-30 respectively. Byte five 32 and byte six 34 are used for the “instructions” within this demonstrated example while byte one 24 through byte four 30 are reserved for future uses of the present invention. Once the basic parts of the message have been defined, a steady state message may be constructed. The instruction bits are set to “0” to generate no action and to “1” to generate an action. In a steady state message no action is required and for demonstration purposes may consist of BDh AAh 55h CCh 3Ch 00h 00h as shown in FIG. 4 for a 7-byte waveform message 20.

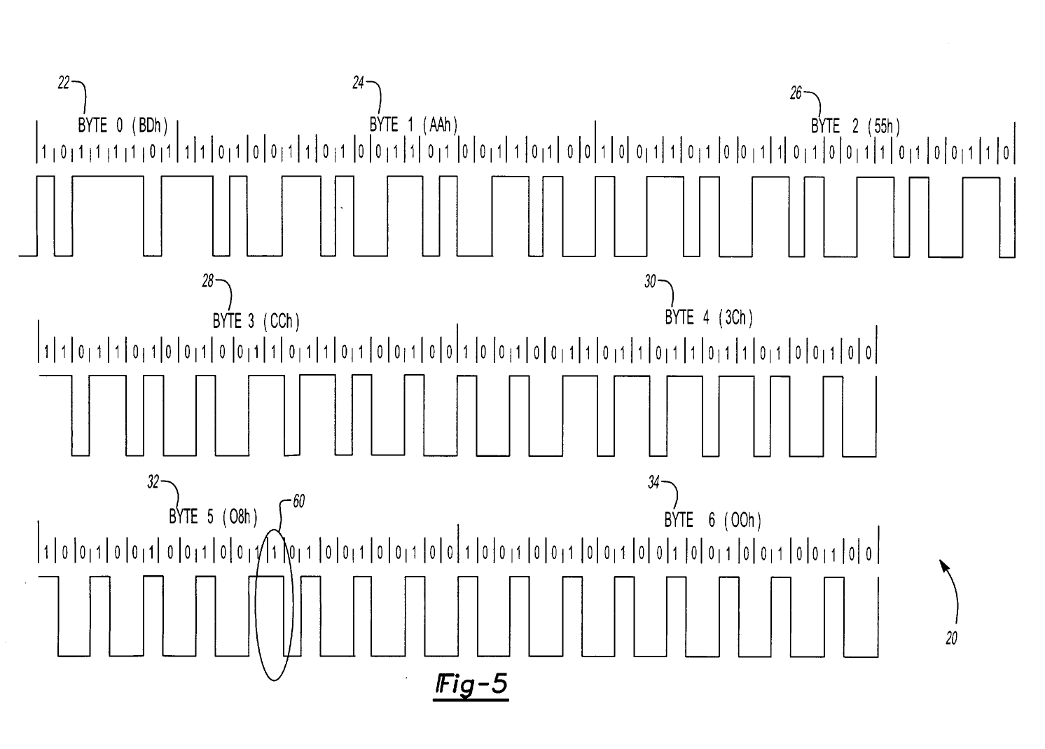

Of 48 possible instructions, one example instruction may include generation of an action in the form of an instruction to cancel an operating cruise control on a vehicle. This cruise cancel instruction can be assigned as the MSB in byte five 32 (FIG. 5). Message 20 would be constructed as BDh AAh 55h CCh 3Ch 08h 00h and is circled at 60 in FIG. 5. In this example, the message in byte five 32 has been changed from 00h to 08h. This is the only change between the waveform in the steady state condition of FIG. 4 and the waveform of FIG. 5, which is shown at 60 in byte five 32. Using this instruction system in this 7-byte waveform message format 20, 48 instructions are possible (each of 6 available bytes has 8 bits and each bit represents one instruction). Each additional byte added to the waveform would add the possibility of an additional 8 new instructions. Thus, using multiple byte waveforms provides versatility and capacity, thereby enabling a comprehensive application system controller to be developed. This greater capacity is becoming increasingly important and necessary in vehicle applications due to the continued development of new accessory features.

As stated previously, the message format of the present invention shown in FIG. 5 can have 48 different instructions that may be sent from a controller source (to be described in more detail later). These 48 instructions could be used to control, on one communication line, such functions in a vehicle as the horn, headlamp flash, marker lamp flash, cruise on/off, cruise set, cruise resume, cruise cancel, wiper wash, wiper speed, wiper off, day light running lamp module, power seat, power mirrors, power foot pedal, power column tilt, radio functions, messages, coach leveling systems, and auxiliary brake control. Given the flexibility and capacity of the system, the only real limit to what can be controlled is the availability of physical space for the controller sources within the vehicle. For example, if a vehicle steering wheel houses the system controller source, it will only be able to contain a limited number of controller sources because of the size of the steering column. Nevertheless, other controller sources can be placed in a number of vehicle locations, all of which can then communicate with a controller area network (CAN) or directly with a remote system controller, which will be referred to as a vehicle system controller (VSC) for purposes of illustrating the application of the invention. Placement of alternate controller sources in a vehicle is known in the art. However, the flexibility and simpler circuitry of the present invention greatly enhance the ability to locate other controller sources in a number of vehicle locations.

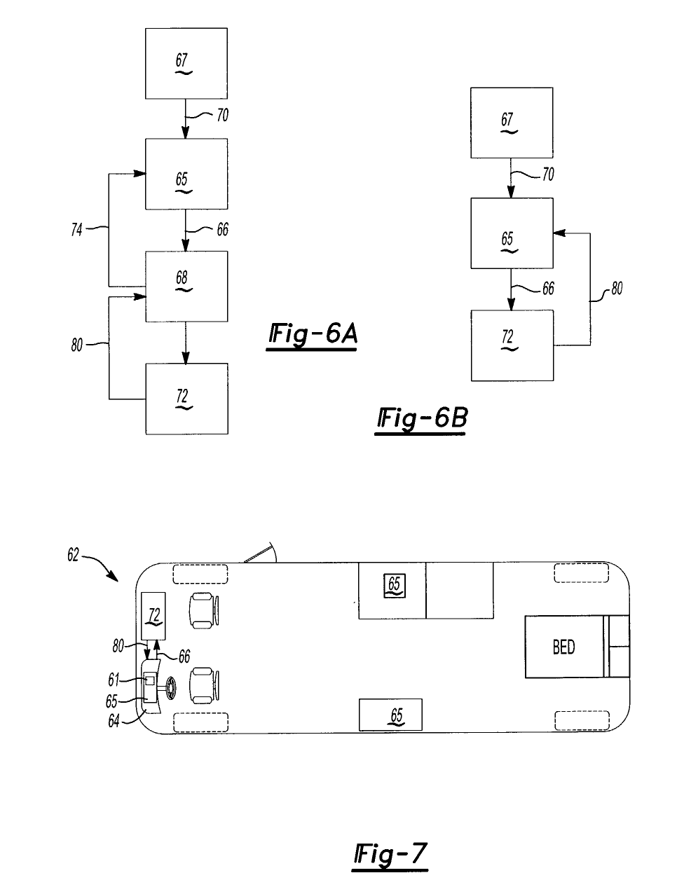

In general, the system of the present invention can include a time division multiplexing system as illustrated in the block diagrams in FIGS. 6A and 6B, using data signals adapted to be sent through the system in a time-dependant cyclical manner. The data signals are sent through the system during each of a series of time intervals using multiple byte waveform technology to communicate between vehicle functions and a remote vehicle system controller 72. System controllers 65 are configured with at least one microcontroller with supporting computer and circuitry components (all of which are commercially available), and can be programmed to generate multiple byte waveforms that are used to communicate with a remote controller through controller outputs 66. System controllers 65 can also receive sensor outputs 70 from vehicle sensors 67. The microcontroller circuitry provides flexibility in the system by allowing the system to be programmed as desired to perform various functions. The system controllers 65 can control various functions and in some situations can also include position memory capability. Position memory enables the system controller 65 to identify or “memorize” a specific predetermined system level or output related to a particular function. The system controller 65 can then return the function to this predetermined level upon demand. Position memory can be used with such vehicle functions as a power foot pedal controller, a power column tilt and telescope controller, a power seat controller, and a power mirror controller. For example, if a person sets the driver's seat in a vehicle to a specific position, the power seat controller can be used to memorize this position and enable the user to be able to simply press a button to reposition the seat to the desired pre-set position.

The system controller outputs 66 may be in communication with a conventional controller area network (CAN) 68 (FIG. 6A) in the form of a commercially available serial bus system J1939, or serial bus system J1708 (without CAN conformity), or directly with VSC 72 (FIG. 6B). For purposes of illustration, a serial bus system conforming to a conventional CAN model will be referred to as the bus system used in the invention and referred to as CAN 68. It is to be understood that a non-CAN bus system could also be used to practice the present invention.

The CAN 68 can communicate with the VSC 72 using time division multiplexing with multiple byte waveforms as described above. The VSC 72 is also configured using microcontroller circuitry, which allows the VSC 72 to communicate and relay signals back to the CAN 68 or directly back to the system controllers 65 via VSC outputs 80. The CAN 68 is also communicatively connected to the system controllers 65 through a plurality of actuator inputs 74. Specifically, as shown in FIG. 7, a vehicle 62 can have a steering wheel/column 64, which houses multiple switch assemblies which are connected to a system controller 65. In this embodiment, system controller 65 includes an encoder circuitry board 61 and can control the horn, headlamp flash, marker lamp flash, cruise on/off, cruise set, cruise resume, cruise cancel, wiper wash, wiper speed (high/low), wiper speed (variable), wiper off, daytime running light module and back light dimming of the steering wheel column. The daytime running light module can include circuitry to allow it to monitor the headlamps and detect headlamp failures. If there is a failure of both of the low beams, the high beams are then activated, but only at the daytime running light intensity level. In the illustrated embodiment of the present invention, each of these functions includes a button or switch that provides an “input” to or signals the system controller 65 when a user actuates the button. System controller 65 of this example generates an encoded signal and communicates directly with the VSC 72 in the form of a multiple byte waveform through system controller outputs 66. The VSC 72 decodes the signal and activates a relay or relays through VSC output 80 to provide power to the appropriate device that has been actuated (e.g. the horn, headlamp, marker lamp, wiper motor, cruise controls, etc.).

In addition to the system controller 65 housed in the steering column/wheel 64, a vehicle 62 could have additional system controllers 65 located throughout vehicle 62 and which can also communicate with the CAN 68 or directly with the VSC 72. This capacity and versatility is needed in all types of motor vehicles and is particularly useful in recreation vehicles (such as motor homes) where there are a variety of possible operations to control. For example, smoke alarms, refrigerators, temperature controls, and automatic step deployment.

As stated previously, the present invention also has the capability of communicating with a standard SAE bus system such as J1708 or J1939. The J1708 is a non-CAN bus and the J1939 is a CAN configured bus. These two busses are typically used in heavy-duty vehicles such as recreational vehicles and can be in communication with the engine, transmission and ABS controller. This allows the remote system controller (VSC 72) of the present invention to communicate directly with these specific functions. Without the system of the present invention, communication with these functions would have to be accomplished through point-to point discrete wiring. Vehicle sensor outputs 70 can also be generated from inputs from such functions as an engine RPM sensor, an accelerator position sensor, a brake position sensor, and an engine temperature sensor. These vehicle sensor outputs 70 may be communicatively connected to the system controllers 65. Flexible, efficient and cost effective communication with these types of sensors would otherwise not be possible using a conventional system. This greater flexibility in the overall control system also permits various control functions to work in conjunction with one another.

For example, the steering wheel system controller 65 in the above example can communicate with the bus that is in direct communication with the engine to determine if the cruise control is actuated. The steering wheel system controller 65 can then actuate an indicator such as a light using a 12V lamp or LED, thus indicating that the cruise is on. In another example, an engine temperature control having a temperature sensor could allow for heat transfer to a water supply within a recreational vehicle when it senses some predetermined engine temperature. Here, the temperature sensor could be integrated with a command from a system controller such as a demand for hot water.

The VSC 72 can be one unit or several units collectively communicating via the CAN 68. The VSC 72 can be placed in any of a variety of protected and remote locations on the vehicle 62. This protects the VSC 72 from exposure to the potentially harsh environment sometimes experienced by vehicle 62.

The microcontroller based system of the present invention allows for incorporating control of some systems of which current conventional systems are not capable. In addition, a microcontroller based system provides superior flexibility over other control systems known in the art due to its ability to be programmed to perform desired functions. For instance, conventional systems can be configured to control the horn, headlamp flash, marker lamp flash, cruise on/off, cruse set, cruise resume, cruise cancel, wiper wash, wiper high/low, wiper variable, and wiper off. Conventional systems are not configured to control such functions as the daytime running lamp module (DRLM), diagnostic operations and back light dimming on the steering wheel column. However, these functions would be possible using the present invention due to the presence of microcontroller based processing in the system.

In addition, the diagnostic capabilities of the present invention allow the control system to conduct self-diagnostics and can actuate indicators, such as a light, indicating there is a failure or malfunction within the system. The indicator could be located externally so that a user could receive the indication, or internally so that it can only be detected while being serviced by a vehicle repairperson.

A description of how the 7-byte waveform message 20 of the present invention can control some exemplary functions through microcontroller logic is as follows:

| | |
|---|---|
| Horn | A horn activation bar (switch) on the steering wheel/ |
| | column can cause a relay on the VSC to supply |
| | power to a horn while the horn bar is pressed. |
| Headlamp Flash | An on-board daytime running lamp (DRL) circuit |
| | can keep low beams illuminated at all times except |
| | when parked. A headlamp flash switch can interrupt |
| | power to the headlamp switch and DRL module and |
| | turn off all headlamp beams (high, low, DRL) for as |
| | long as the headlamp flash button is pressed. Off-to- |
| | on flash feature for headlamps can be provided in |
| | neutral as long as the headlamp flash button is |
| | pressed. In that case, the headlamps will flash at the |
| | DRL illumination level. |
| Marker Lamp Flash | If marker lamps are turned on, pressing a marker |
| | lamp flash switch can cause the lamps to turn off |
| | while the switch is pressed. Likewise, if the marker |
| | lamps are not turned on, pressing the marker lamp |
| | switch will turn them on while the switch is pressed. |
| Cruise On/Off | Pressing a cruise on/off switch toggles the cruise on/ |
| | off relay thus switching the cruise control between |
| | on and off conditions. A status indicator will show |
| | the selected condition. The cruise on/off status will |
| | be determined by monitoring the CAN and decoding |
| | the pulse train. The n/o and n/c (normal open/normal |
| | close) relay terminals can be connected directly to |
| | the engine cruise control module. |
| Cruise Set | Pressing a cruise set switch can activate a cruise set |
| | relay while the cruise set switch is depressed and |
| | thereby activates the cruise set function of the |
| | engine system controller. The n/o and n/c relay |
| | terminals can be connected directly to the engine |
| | cruise control module. A status indicator will show |
| | if the cruise system is in set condition. The |
| | cruise set status will be determined by monitoring |
| | the CAN and decoding the train. An on-board |
| | selector DIP switch that determines the signal |
| | present on the com relay terminal of the cruise set |
| | relay will provide variations in operation by |
| | chassis/engine configuration. |
| Cruise Resume | Pressing a cruise resume switch can activate a cruise |
| | resume relay and thereby activates the cruise resume |
| | function of the engine controller. The n/o and n/c |
| | relay terminals can be connected directly to an |
| | engine cruise control module within the VSC or as a |
| | stand-alone controller. An on-board selector DIP |
| | switch that determines the signal present on the com |
| | relay terminal of the cruise resume relay can provide |
| | variations in operation by chassis/engine configura- |
| | tion. |
| Cruise Cancel | Pressing the cruise cancel activation switch can |
| | activate a spdt (single pole-double throw) cruise |
| | cancel relay. All relay terminals (n/o, n/c) are |
| | terminated for connection to the VSC. |
| Wiper Wash | Pressing a wiper wash switch can activate a wash |
| | pump relay. If the wiper wash switch is pressed |
| | while another wiper function (wiper high, wiper |
| | low, wiper variable) is in operation, the wipers |
| | will continue in the selected mode while the wiper |
| | wash switch is pressed and after it is released. |
| Wiper High/Low | Pressing a wiper high/low switch once activates the |
| | low speed wiper relay. Subsequent pressing of the |
| | switch can cause the wiper speed relay to toggle |
| | between low speed and high speed. |
| Wiper Variable | A variable wiper function can be configured to have |
| | six discrete speeds (duration of pause between slow |
| | speed wipes). Pressing a wiper variable switch once |
| | engages the slowest speed (longest duration |
| | pause) and each successive press of the switch |
| | activates the next fastest speed (next shortest |
| | pause duration). After six presses of the switch the |
| | variable wiper function will return to the slowest |
| | speed (longest duration pause) setting and each |
| | successive press will activate the next fastest speed |
| | (next shortest pause duration). Therefore, the speed |
| | of the variable wiper function is selected in a |
| | cyclical manner. Pressing the wiper high/low switch |
| | of the wiper off switch will override the wiper |
| | variable function and wiper operation will proceed |
| | according to the switch selected. (See wiper high/ |
| | wiper low and wiper off operation descriptions). |
| Wiper Off | Pressing a wiper off switch cancels any wiper func- |
| | tion previously selected. All wiper functions are |
| | cancelled when ignition is turned off. |
| Diagnostic Feature | A “system OK” status lamp or LED (off-board) |
| | will illuminate if all conditions within any pre- |
| | determined configuration are met for standard |
| | operations. A set of three off-board lamps or LEDs |
| | (i.e., cruise set indicator, cruise on indicator and |
| | system OK indicator) can display the status of up to |
| | seven failures based on vehicle sensor outputs (e.g., |
| | communication links, headlamps filaments, etc.) |
| | detected by the diagnostic subroutine. The diag- |
| | nostic subroutine can be activated by an external |
| | switch. |

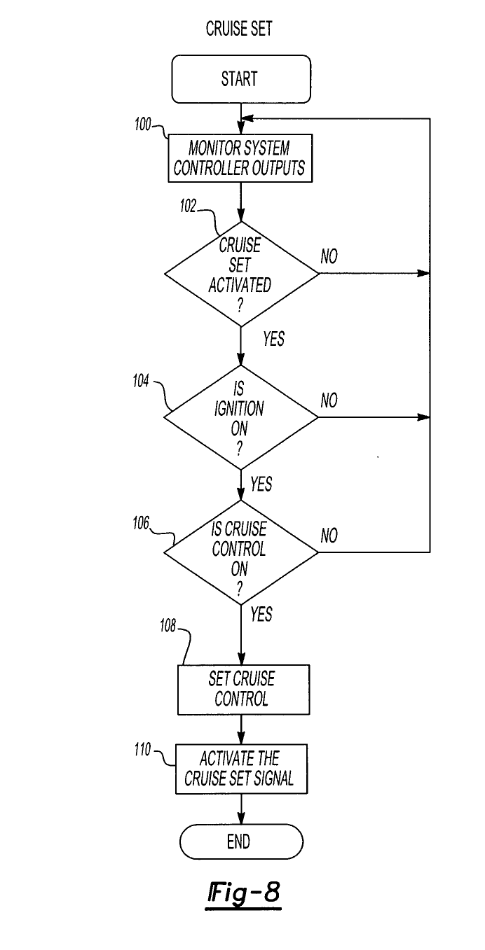

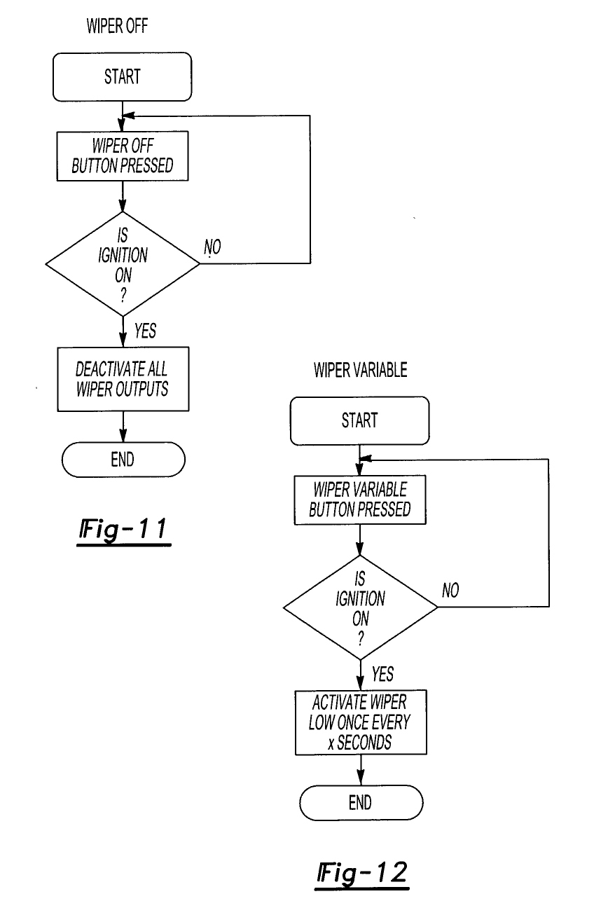

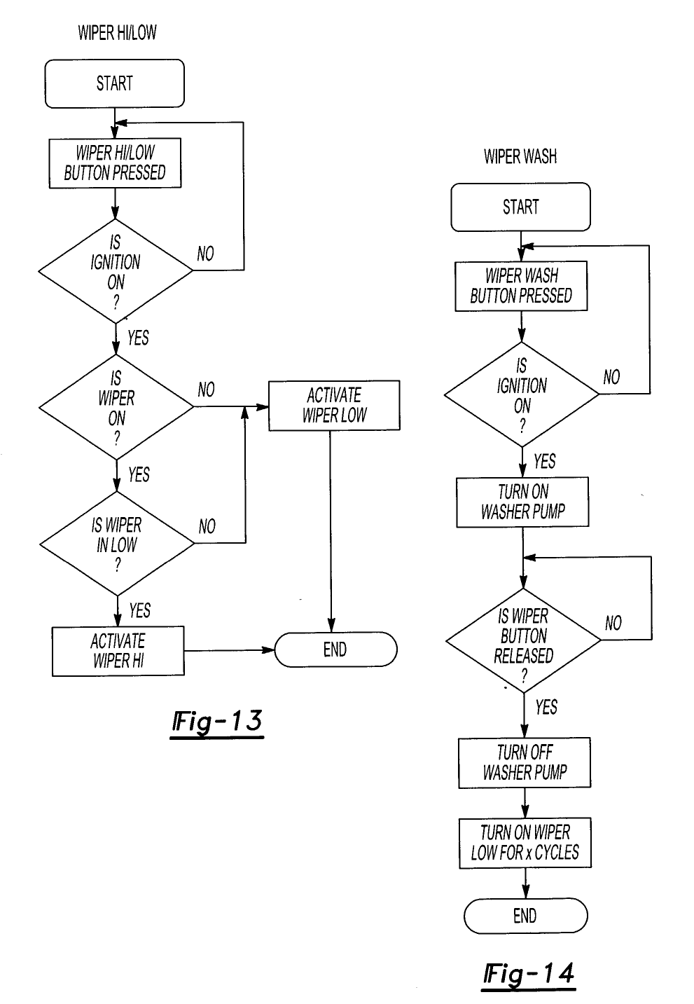

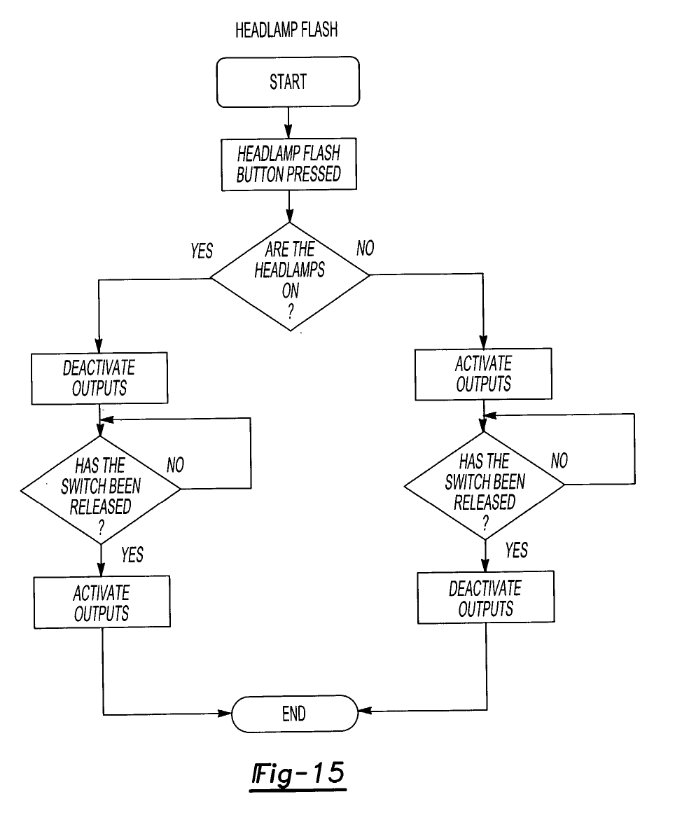

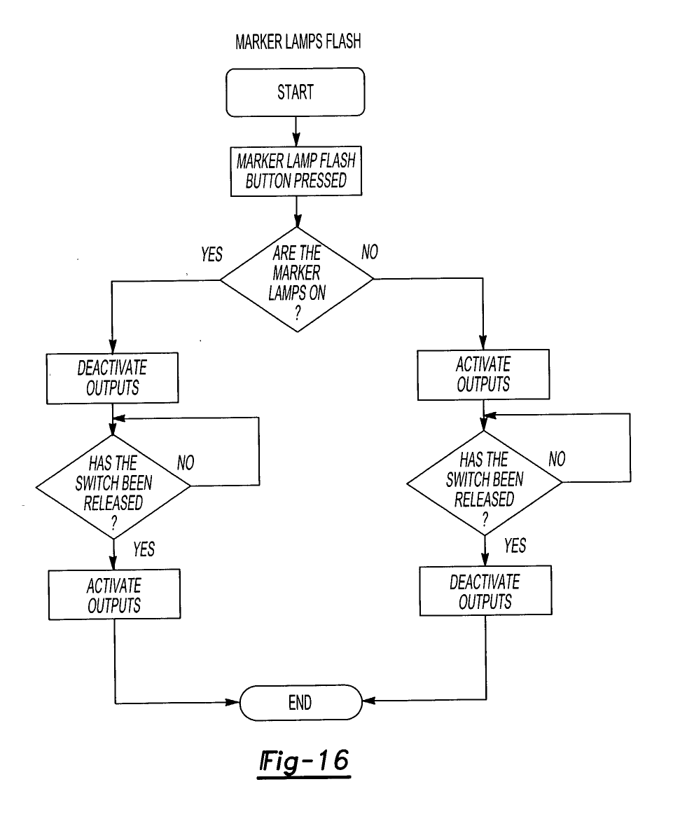

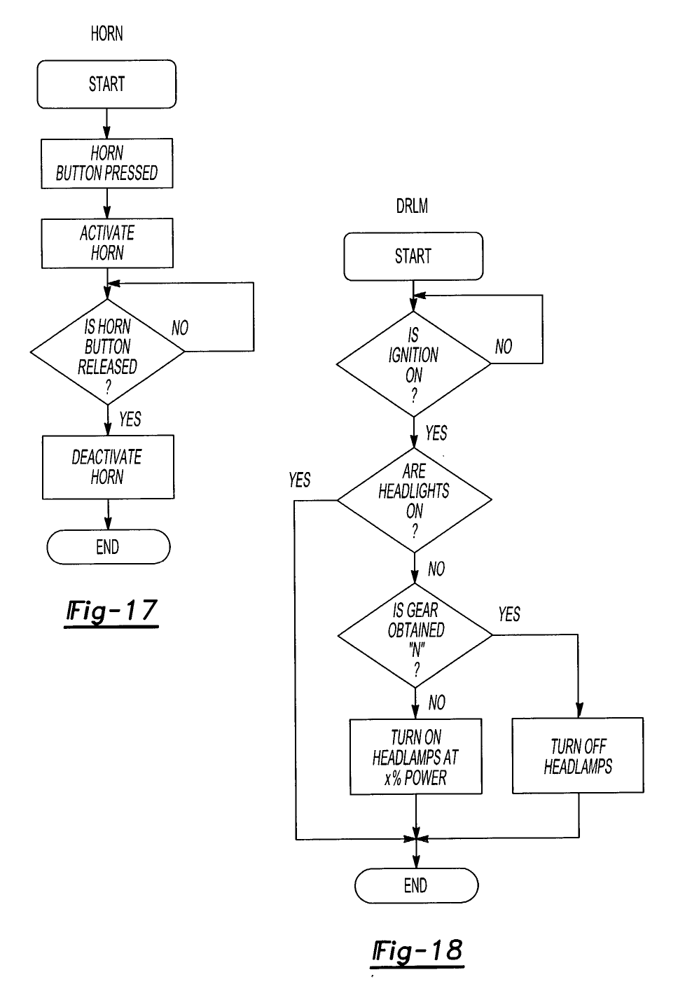

Block diagrams illustrating system strategies for the functions described above are illustrated in FIGS. 8-18. These strategies can include cruise set, cruise resume, cruise cancel, wiper off, wiper variable, wiper hi/low, wiper wash, headlamp flash, marker lamps flash, horn, and DRLM. Of course, a variety of system strategies can be added or removed as needed for a particular application. By way of example, FIG. 8 shows a strategy for a cruise set. In FIG. 8, the strategy starts at step 100, where the VSC 72 monitors encoded controller outputs 66, specifically for the position of the cruise set controller, ignition controller (key on/off), and the cruise on/off controller. Next, at step 102 the strategy determines whether the cruise set controller is activated. If yes, the strategy proceeds to step 104. If no, the strategy cycles back to step 100.

At step 104, the strategy determines whether the ignition controller is “on.” If yes, the strategy proceeds to step 106. If no, the strategy cycles back to step 100.

At step 106, the strategy determines whether the cruise control is “on.” If no, the strategy cycles back to step 100. If yes, the strategy commands the VSC 72 to command the cruise to be set at step 108. Next the strategy proceeds to step 110 and commands the VSC 72 to activate a “cruise set” indicator lamp.

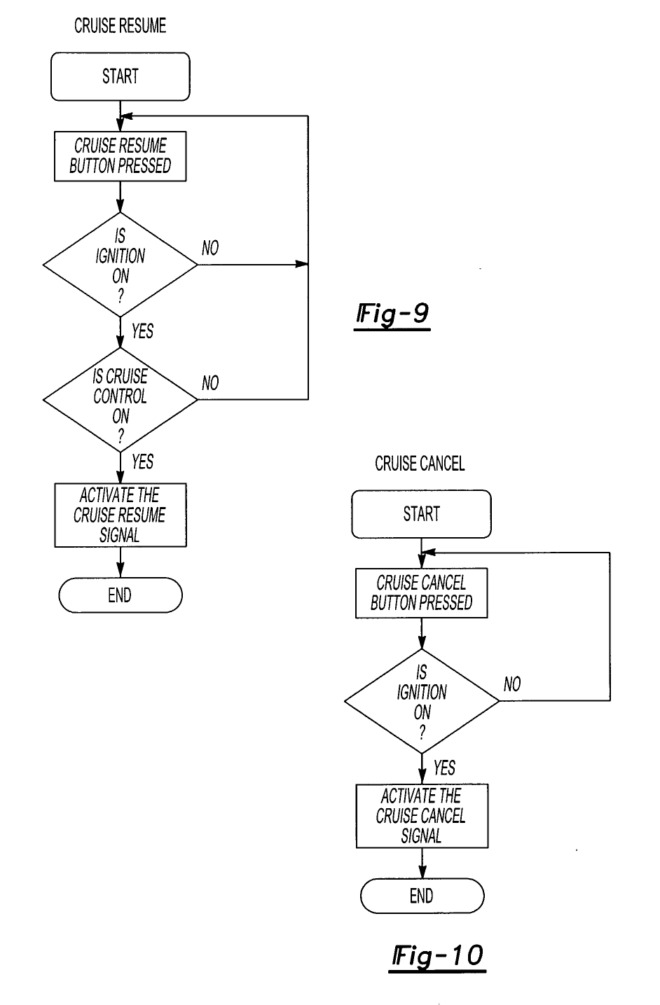

FIGS. 9 through 18 illustrate other strategies running concurrently to control other vehicle applications using the 7-byte multiple waveform technology in time division multiplexing. Various alterations and changes can be made to the illustrated embodiment of the present invention without departing from the spirit and broader aspects of the invention as set forth in the appended claims, which are to be interpreted in accordance with the principles of patent law, including the doctrine of equivalence. The embodiment of the invention in which exclusive property or privileges claimed is defined as follows.

We claim:

1. A time division multiplexing system, using data signals adapted to pass through the system in a cyclical manner during each of a series of time intervals, comprising:
at least one system controller generating at least one controller output in the form of a multiple byte waveform, said at least one controller output communicates with a remote system controller using said multiple byte waveforms; and
wherein said system controller monitors bits in a binary configuration to identify time intervals associated with said at least one controller output.

2. The system of claim 1, wherein said remote system controller relays signals to said at least one system controller to actuate a function.

3. The system of claim 1 further including at least one system bus communicatively connected to said at least one system controller and said remote system controller.

4. The system of claim 3, wherein said system bus includes a controller area network configuration.

5. The system of claim 4, wherein said system bus includes an SAE J1939.

6. The system of claim 3, wherein said system bus includes an SAE J1708.

7. The system of claim 1, wherein said at least one system controller includes a microcontroller circuit.

8. The system of claim 1, wherein said at least one system controller includes an encoder board.

9. The system of claim 7, wherein said controller outputs include an encoded signal.

10. The system of claim 2, wherein said remote system controller signals include a decoded signal.

11. The system of claim 1, wherein said remote system controller sends relay signals to actuate indicators.

12. The system of claim 1, wherein said multiple byte waveform comprises a 7-byte waveform.

13. The system of claim 1, wherein said at least one system controller includes a daytime running light module.

14. The system of claim 13, wherein said at least one system controller includes circuitry to monitor low headlamp failure and upon failure of both low beams to activate high beams at daytime running light intensity.

15. The system of claim 1, wherein said at least one system controller includes a controller to dim the back lighting on a steering wheel.

16. The system of claim 1, wherein said at least one system controller includes diagnostics capabilities.

17. The system of claim 1, wherein said at least one system controller includes a power foot pedal control having position memory.

18. The system of claim 1, wherein said at least one system controller includes a power column tilt and telescope control having position memory.

19. The system of claim 1, wherein said at least one system controller includes auxiliary brake controls.

20. The system of claim 1, wherein said at least one system controller includes a power seat controller having position memory.

21. The system of claim 1, wherein said at least one system controller includes a power mirror controller having position memory.

22. The system of claim 1 further including at least one vehicle sensor communicatively connected to said at least one system controller.

23. The system of claim 22, wherein said at least one vehicle sensor includes an engine RPM sensor.

24. The system of claim 22, wherein said at least one vehicle sensor includes an accelerator position sensor.

25. The system of claim 22, wherein said at least one vehicle sensor includes a brake position sensor.

26. The system of claim 22, wherein said at least one vehicle sensor includes an engine temperature sensor.

27. The system of claim 1, wherein a specific time interval is associated with a specific vehicle component and wherein said bits associated with said time interval represent a command to actuate said associated vehicle component.

28. A time division multiplexing system for a vehicle, using data signals adapted to pass through the system in a cyclical manner during each of a series of time intervals, comprising:
at least one system controller generating at least one controller output and including a microcontroller circuitry, said at least one controller output communicatively connected to a vehicle system controller using a multiple byte waveform signal to communicate with said vehicle system controller.

29. The system of claim 28, wherein said vehicle system controller monitors bits in a binary configuration to identify time intervals associated with said at least one controller output.

30. The system of claim 29, wherein a specific time interval is associated with a specific vehicle component and wherein said bits associated with said time interval represent a command to actuate said associated vehicle component.

31. A time division multiplexing system for a vehicle, using data signals adapted to pass through the system in a cyclical manner during each of a series of time intervals, comprising:
at least one system controller generating at least one controller output in the form of multiple byte waveforms, said at least one controller output communicatively connected to a serial bus system;
said serial bus system communicatively connected to a vehicle system controller; and
said vehicle system controller configured to monitor bits in a binary configuration to identify time intervals associated with said at least one controller output.

32. A time division-multiplexing system according to claim 31, wherein a specific time interval is associated with a specific vehicle component and wherein said bits associated with said time interval represent a command to actuate said associated vehicle component.

33. A time division multiplexing system according to claim 31, wherein said at least one system controller includes microcontroller circuitry.
